(19) United States
(12) Patent Application Publication
(10) Pub. No.: US 2025/0056697 A1
(43) Pub. Date: Feb. 13, 2025

(54) AMBIENT LIGHT SENSING EMULATION SYSTEMS AND METHODS

(71) Applicant: Lattice Semiconductor Corporation, Hillsboro, OR (US)

(72) Inventor: Satheesh Chellappan, El Dorado Hills, CA (US)

(21) Appl. No.: 18/796,167

(22) Filed: Aug. 6, 2024

Related U.S. Application Data
(60) Provisional application No. 63/518,086, filed on Aug. 7, 2023.

(51) Int. Cl. H05B 47/11; G06T 7/90

(52) U.S. Cl. CPC H05B 47/11; G06T 7/90; G06T 2207/10004; G06T 2207/10016; G06T 2207/10024; G06T 2207/20076; G06T 2207/30196

(57) ABSTRACT

Various techniques are provided to emulate an ambient light sensor and determine an ambient color temperature. A programmable logic device includes an image processing pipeline with hardware components configured to process an image frame received from an image capture device, ambient light sensing hardware coupled to the image processing pipeline and configured to generate an ambient light value from the image frame, and a memory configured to store the ambient light value for use by a host system processor. The host system processor may be configured to selectively adjust a brightness and/or display color settings based on the ambient light value. The programmable logic device may be configured to operate in accordance with a polling interval. User presence data comprising audio, video, and/or user input data may be collected and fused with the ambient light value for use by the host processor.

### CROSS REFERENCE TO RELATED APPLICATIONS

This application claims priority to and the benefit of U.S. Provisional Patent Application No. 63/518,086 filed Aug. 7, 2023, and entitled “AMBIENT LIGHT EMULATION SYSTEMS AND METHODS,” which is incorporated herein by reference in its entirety.

### TECHNICAL FIELD

The present invention relates generally to ambient light sensing and, more particularly, to systems and methods for emulating ambient light sensors.

### BACKGROUND

Ambient light sensors are commonly used in client, consumer and industrial systems. For example, ambient light sensors may be used to sense the ambient light around a display screen and implement certain actions, such as increasing a display brightness to enhance a user experience in a bright environment (e.g., outdoors on a sunny day) or decreasing the display brightness in a dark environment (e.g., indoors in a dark room) to save power, increase battery life, and improve the user experience.

Adding a dedicated ambient light sensor to a device increases the cost with the addition of the ambient light sensor hardware, wires, enabling software, and other dedicated system resources (e.g., printed circuit board space, additional output I2C interface, etc.). The placement of the ambient light sensor is generally selected to assist in obtaining a uniform reading of the ambient light. For example, in a laptop, a discrete ambient light sensor is often located on a lower portion of a lid with the display, which adds additional wires over the hinge between the lid and the main processing components.

### BRIEF DESCRIPTION OF THE DRAWINGS

FIG. 1 illustrates a block diagram of an example hardware system for facilitating ALS emulation in accordance with one or more embodiments of the present disclosure.

FIG. 2A illustrates an example environment implementing ALS emulation in accordance with one or more embodiments of the present disclosure.

FIG. 2B illustrates an example environment implementing ALS emulation in accordance with one or more embodiments of the present disclosure.

FIG. 3 illustrates an example implementation of logic and/or circuitry for an image processing pipeline including ALS emulation in accordance with one or more embodiments of the present disclosure.

FIG. 4 illustrates a flow diagram of an example process for facilitating ALS emulation in accordance with one or more embodiments of the present disclosure.

FIG. 5A is a diagram illustrating an example operation of ALS emulation in accordance with one or more embodiments of the present disclosure.

FIG. 5B illustrates an example data structure for transmitting Lux values between the imaging pipeline and the host system in accordance with one or more embodiments of the present disclosure.

FIG. 6 illustrates a flow diagram of an example process for facilitating ALS emulation and color temperature calculation in accordance with one or more embodiments of the present disclosure.

FIG. 7 illustrates an example mapping of pixel values to Lux values in accordance with one or more embodiments of the present disclosure.

FIG. 8 illustrates an example relationship between pixel values and lux values in accordance with one or more embodiments of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with various embodiments set forth herein, ambient light sensing (ALS) and ambient color temperature sensing (ACS) are emulated using an imaging sensor of a device. The imaging sensor may be implemented as a camera on a client device such as a laptop computer, a mobile device, a display, an accessory device, an Internet-of-things system, or other system or device. The client device may further include an image processing pipeline and other processing hardware and software for processing captured image frames. The imaging sensor may be used to capture an image frame for and emulate both ALS and ACS functions. In various embodiments, an ALS hardware block is configured to generate luminance values (e.g., Lux) and Kelvin values from the captured images to emulate an ambient light sensor and generate ALS data for use by the client device.

In various embodiments, an image is captured, which has both luma and chroma components. A luma vector from the image includes a brightness component that may be used to generate a Lux value. Additionally, a chroma vector from the image includes color temperature information that may be used to generate a Kelvin value. These values may be combined with other sensor info and/or data from the client device for use in managing performance (e.g., display brightness) and power usage of the client device.

In accordance with various embodiments, a method includes receiving an image frame from an imaging sensor as pixels on a line-by-line basis. Luma and chroma statistics may be collected for the whole image frame and/or a subset of the pixels (e.g., which may be represented as a grid of pixels). The statistics are arranged in a histogram with a programmable range selected based on accuracy requirements for the system. It is observed that many consumer use cases have generally coarse accuracy and built-in hysteresis. In some implementations, a cumulative distribution function (CDF) may be used to generate results with a higher accuracy.

The statistical collection may be performed in the hardware which may include an ALS hardware block, and the computations may be performed in a logic device (e.g., a RISCV) which may be further configured using firmware. In various embodiments, the systems and method may further include image grid selection, elimination of outliers, an imaging sensor agnostic programmable lookup table (LUT), dynamic and/or autonomous rate of ALS reporting, fusing of ALS reporting with other sensor data, and other techniques. In some embodiments, the client device includes a companion chip, such an artificial intelligence FPGA chip, which performs as an offload chip to save power and prefetch technology may not otherwise be available in the device system processor/system on a chip (SoC).

The ALS and ACS sensor emulation as disclosed herein may be implemented in a companion chip, allowing the device to implement ALS power management, display adaptation, and other features without requiring a discrete ALS sensor, thereby reducing costs and improving performance. In some embodiments, the companion chip is configured with an ALS controller block that is integrated into the camera path. Programmable parameters may be moved to firmware of the system logic device.

For many consumer systems, a high accuracy of ALS values is not required, allowing the systems and methods disclosed herein to be used to meet the consumer system accuracy tolerance requirements even in consumer systems with lower quality cameras. Adding a costly discrete ALS sensor which provides fine calibrated measurement may be superfluous for consumer applications where the primary uses are to increase or reduce panel brightness for better user experience and/or save power.

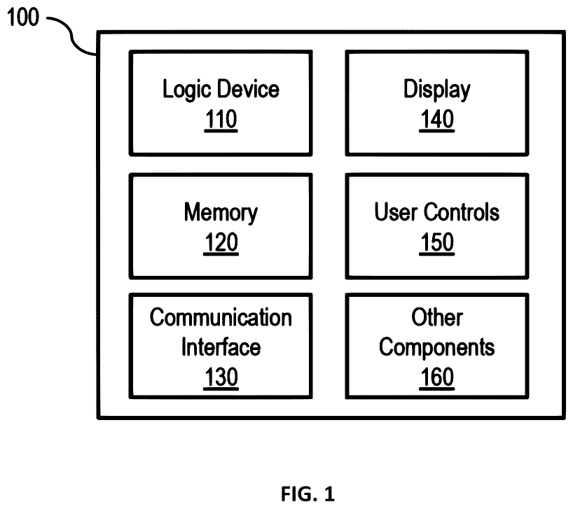

Referring now to the drawings, FIG. 1 illustrates a block diagram of an example hardware system 100 for facilitating ALS emulation in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided.

The hardware system 100 includes a logic device 110, a memory 120, a communication interface 130, a display 140, user controls 150, and other components 160. The logic device 110 may be implemented as any appropriate device(s) used for data processing such as a processor (e.g., a microprocessor, a single-core processor, and/or a multi-core processor), a microcontroller, a PLD (e.g., an FPGA, a complex programmable logic device (CPLD), a field programmable system on a chip (FPSC), an application-specific integrated circuit (ASIC), or other types of programmable devices), a graphics processing unit (GPU), and/or other devices. In some embodiments, the logic device 110 may perform ALS emulation as described herein.

PLDs may be configured with various user designs to implement desired functionality. Typically, the user designs are synthesized and mapped into configurable resources, including by way of non-limiting example programmable logic gates, lookup tables (LUTs), embedded hardware, interconnections, and/or other types of resources, available in particular PLDs. Physical placement and routing for the synthesized and mapped user designs may then be determined to generate configuration data for the particular PLDs. The generated configuration data is loaded into configuration memory of the PLDs to implement the programmable logic gates, LUTs, embedded hardware, interconnections, and/or other types of configurable resources.

In some embodiments, the logic device 110 may include a multi-chip module/system with a PLD on one chip and a processor (e.g., an instruction processor for executing instructions) on another chip. Die-to-die interfaces may be used to facilitate communication between the dice of a multi-chip architecture. The processor may be provided on an SoC platform and the PLD may be provided separate from the SoC platform. In other embodiments, the logic device 110 may include a PLD and a processor on the same chip. The logic device 110 may include a processor implemented as part of an SoC with a PLD fabric, the processor may be in a package (e.g., as a chiplet) with the PLD, and/or the processor and the PLD may be on the same board. In some cases, the processor may have more processing resources than the PLD and may thus be referred to as a main processor or a central processor (e.g., relative to a programmable logic element like a PLD and for purposes of implementing the processes described herein).

The memory 120 may be implemented by one or more memory devices providing machine readable mediums such as volatile memory (e.g., random access memory), non-volatile non-transitory memory (e.g., read-only memory, electrically-erasable read-only memory, flash memory), or other types of memory. In various embodiments, the memory 120 may store software instructions to be executed by the logic device 110 and/or used to configure the logic device 110 in accordance with the various operations discussed herein, data inputs received by the hardware system 100 (e.g., via the communication interface 130) and/or information (e.g., metadata such as timestamps, data type, data size, etc.) associated with the data inputs, data outputs generated by the hardware system 100 (e.g., outputs such as inferences generated by the logic device 110), and/or other information as appropriate. Although the memory 120 is illustrated as being a separate component, the memory 120 may represent memory of other components, such as the logic device 110, alternative to or in addition to memory separate from the other components.

The communication interface 130 may be implemented with appropriate hardware to provide wired and/or wireless data communication between the various components of the system 100 and/or between the system 100 and other devices. For example, in some embodiments, the communication interface 130 may be a network interface (e.g., an Ethernet interface, a Wi-Fi interface, and/or others), a serial interface, a parallel interface, and/or other types as appropriate. For example, one or more of the communication interfaces 130 may be provided to receive data inputs from external devices (e.g., from networked cameras or file systems), pass communications among the various components of the system 100, and/or provide data outputs among the various components and/or to external devices. In some embodiments, the communication interface 130 may include an image capture device interface (e.g., MIPI DPHY camera interface) to provide wired and/or wireless data communication between the system 100 and an image capture device coupled to the system 100 and a communication interface between a PLD of the logic device 110 and a processor of the logic device 110, as further described herein.

The display 140 may be implemented with appropriate hardware to present information to a user of the system 100. For example, in some embodiments, the display 140 may be implemented by a screen, touchscreen, and/or other appropriate hardware. The display 140 may be configured to present to a user various icons, images, and/or text (e.g., through a graphical user interface (GUI) or otherwise) provided by one or more applications, including an operating system, running on the logic device 110. For example, the display 140 may be configured to present images, such as images captured by an image capture device (e.g., camera) communicatively coupled to the system 100 and analyzed by the logic device 110 in accordance with one or more embodiments. Further, the display 140 may be a touchscreen display configured to receive user input and user selection based on user contact with the touchscreen. The touchscreen may generate a signal in response to a user contact and transmit the signal to the logic device 110. A user may thus interact with the information presented on the touchscreen.

The user controls 150 may be implemented with appropriate hardware to permit a user to interact with and/or operate the system 100. For example, in some embodiments, user controls may be implemented by various components such as keyboard, mouse, trackpad, touchscreen (e.g., in some cases integrated with the display 140), buttons, slide bars, knobs, and/or other appropriate hardware. Other components 160 may be provided to implement any additional hardware features as appropriate for particular implementations. As non-limiting examples, other components 160 may include a global positioning system (GPS), a temperature sensor, a gaze direction sensor, and/or others.

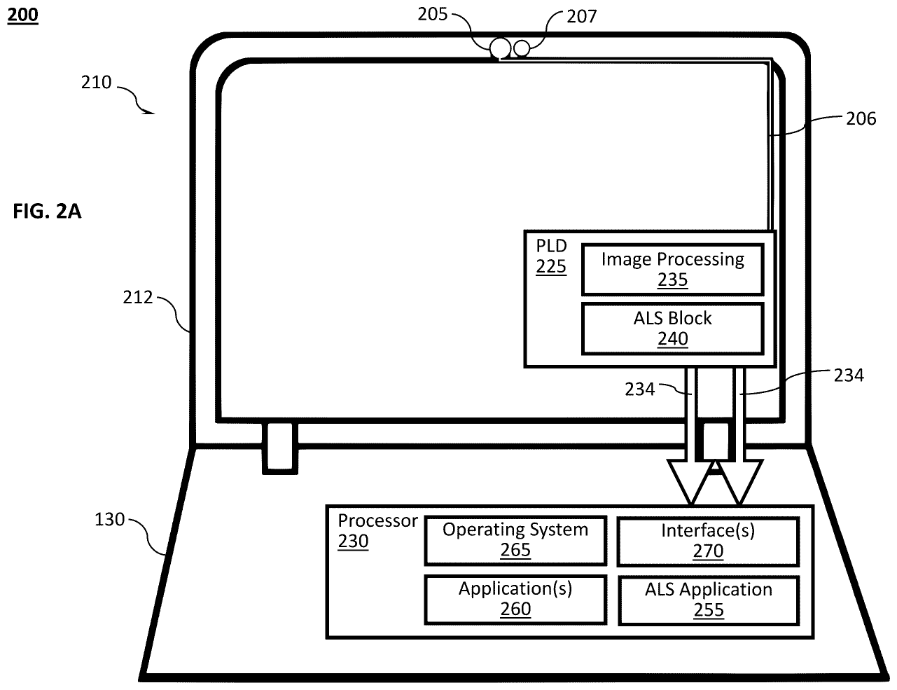

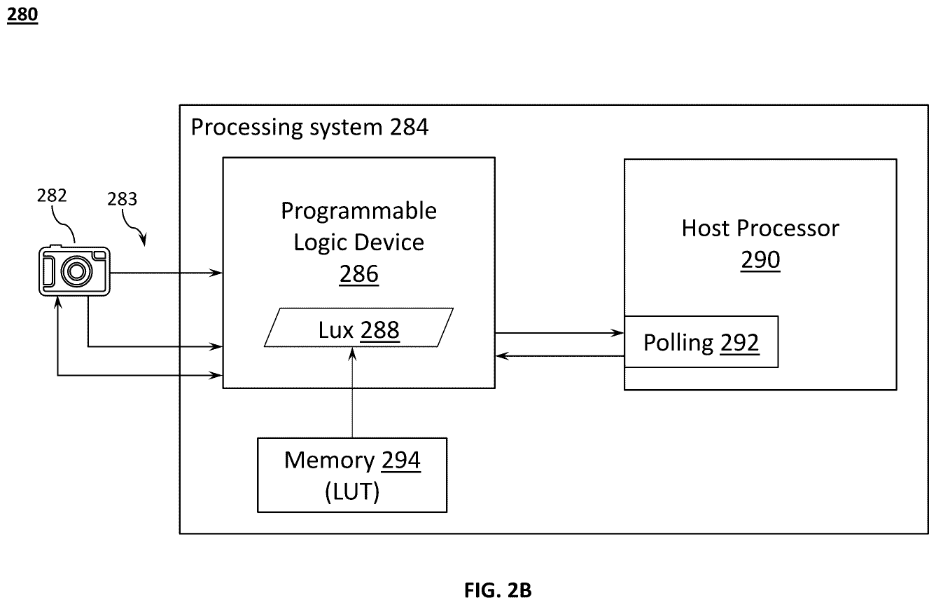

FIG. 2A illustrates an example environment 200 (e.g., an implementation of system 100 of FIG. 1) in which ALS emulation may be performed in accordance with one or more embodiments of the present disclosure. Not all of the depicted components may be required, however, and one or more embodiments may include additional components not shown in FIG. 2A. Variations in the arrangement and type of the components may be made without departing from the spirit or scope of the claims as set forth herein. Additional, fewer, and/or different components may be provided.

The environment 200 includes an image capture device 205 (e.g., a camera) and a device 210 (e.g., a laptop computer). The image capture device 205 may include detectors/sensors to capture an image of a scene within a field of view of the image capture device 205. The image capture device 205 may capture individual static images and/or a series/sequence of images (e.g., according to a frame rate) in a video sequence. In some implementations, the images may include streamed images for a videoconference that are captured by the image capture device 205. An image may be referred to as a frame or an image frame. In some embodiments, the device 210 may be a user device, such as a smartphone, a tablet, or a laptop, and the image capture device 205 may be a built-in camera of the device 210. As an example, the image capture device 205 may be a camera embedded in a lid 212 of a laptop or an external camera positioned on or proximate to a monitor.

The device 210 includes a logic device. In some embodiments, the device 210 may be, may include, or may be a part of, the system 100 of FIG. 1, and/or the logic device may be, may include, or may be a part of, the logic device 110 of FIG. 1. In the illustrated embodiment, the logic device includes a PLD 225 (e.g., a logic device and/or PLD (e.g., an ASIC) as described with reference to FIG. 1) and a processor 230 (e.g., an instruction processor). The PLD 225 includes an image processing logic 235 including an image capture interface configured to provide communications to and/or from image capture device 205, and including an image processing pipeline. The PLD 225 may receive the images from the image capture device 205 via the image capture device interface and/or from other sources (not shown), such as from a memory that stores images for retrieval and processing by the PLD 225. The image capture device interface provides/facilitates wired and/or wireless data communication between the PLD 225 and the image capture device 205, such as via image capture interface 206. As an example, in some cases, the image capture interface 206 may support the Mobile Industry Processor Interface (MIPI) Camera Serial Interface (CSI). In various embodiments, the image processing logic 235 receives and processes image from the image capture device 205 for use by the processor 230.

The PLD may further comprise an ALS block 240 configured to receive image frame(s) and generate ALS and/or ACS data. In accordance with various embodiments, the ALS block may be configured to generate Luma and chroma statistics associated with the pixels of a received image and/or a subset of the pixels (e.g., which may be represented as a grid of pixels). In some embodiments, the statistical collection may be performed in the hardware which may include an ALS hardware block, and the computations may be performed in a logic device (e.g., a RISCV), such as processor 230, which may be further configured using firmware.

The processor 230 may read and execute machine readable instructions to implement ALS Application 255, one or more applications 260, an operating system 265, and one or more interfaces 270. The machine-readable instructions may be stored in one or more memory devices (e.g., the memory 120), such as a non-transitory machine-readable medium, which may form a part of the processor 230 and/or may be accessible to the processor 230. Although the processor 230 is described in relation to its software, the processor 230 may also include hardware. A communication interface (e.g., the communication interface 130) may be implemented as a wired and/or wireless interface to connect the device 210 with various external devices to update the operating system 265, update the application(s) 260, update the ALS Application 255, and/or communicate data.

The ALS Application 255 is configured to process ALS data received from the ALS block 240 to emulate ALS functionality. The ALS data may be arranged a histogram with a programmable range selected based on accuracy requirements for the system. In some implementations, a cumulative distribution function (CDF) may be used to generate results with a higher accuracy. In this embodiment, the statistical collection is performed in the hardware (e.g., ALS block 240) and the computations may be performed on processor 230 which may be further configured using firmware. In various embodiments, the systems and method may further include image grid selection, elimination of outliers, an imaging sensor agnostic programmable lookup table (LUT), dynamic and/or autonomous rate of ALS reporting, fusing of ALS reporting with other sensor data, and other techniques. In some embodiments, the environment 200 includes a companion chip, such an artificial intelligence FPGA chip. The ALS and ACS emulation as disclosed herein may be implemented in a companion chip, allowing the device to implement ALS power management, display adaptation, and other features without requiring a discrete ALS sensor, thereby reducing costs and improving performance. In some embodiments, the companion chip is configured with an ALS controller block that is integrated into the camera path. Programmable parameters may be moved to firmware of the system logic device (e.g., processor 230).

The application(s) 260 may include one or more applications that facilitate interaction between the device 210 and the image capture device 205. In some cases, the one or more applications 260 may receive image data from the image capture device 205. In some embodiments, the applications 260 may process captured images from the image capture device 205 and provide the processed image data to one or more of the other application(s) 260, the operating system 265, and/or one or more applications running on another device.

The one or more of the application(s) 260 may further operate on data from the ALS Application 255. Other of the application(s) 260 may be unrelated to operation of the ALS emulation described herein. In some implementations, the application(s) that operate on data from the image capture device 205 and/or ALS data may include an end user application(s) that is more readily accessible and adjustable to a user (e.g., of the device 210) than the PLD 225. In some cases, one or more of the application(s) 260 may present information (e.g., icons, images, and/or text) on a display component (e.g., the display 140). As an example, the application(s) 260 may include a videoconference application, an automotive application, and/or other application that may be run on the device 210 (e.g., on the operating system 265 of the device 210). The application(s) 260 may be application software written in a computer programming language such as Java™, Objective-C, Swift, and/or other computer programming language, and may be in an appropriate packaged file format configured to be distributed, installed, and run on the processor 230.

The operating system 265 may configure the processor 230 to manage various hardware and software components of the device 210 that includes the PLD 225 and the processor 230 and provide services for the various hardware and software components. In this regard, it will be appreciated that additional software (e.g., executable instructions) and hardware may be provided as part of or in communication with the operating system 265 to implement appropriate communication between various components of the device 210 including, for example, TCP/IP stack and/or UDP stack, drivers for external devices (e.g., with such drivers including a sensor driver to permit access to and/or communication with the image capture device 205), and/or other operations. Such hardware and software may include the various components described in relation to the system 100 of FIG. 1, such as the memory 120, the communication interface 130, the display 140, the user controls 150, and/or the other components 160.

The interface(s) 270 may be provided to facilitate appropriate communication between various components of the device 210 with each other as well as between the device 210 and one or more additional devices (e.g., devices integrated with the device 210 and/or devices external to/separate from the device 210). The interface(s) 270 may include an application programming interface (API) that enables the sensor driver and the application(s) 260 to call and be called by the operating system 265, the sensor driver to call and be called by the application(s) 260, and so forth. It is noted that FIG. 2A shows various example connections related to data flow associated with object detection and assessment. Additional connections may be present in the environment 200 although not explicitly shown in FIG. 2A.

FIG. 2A illustrates an example environment that may include a laptop computer. It will be appreciated that other example environments utilizing ambient light readings (e.g., a system with a display, a control system using ambient light values to set controls (e.g., lighting controls), etc.) may also be implemented. FIG. 2B illustrates another example environment 280 in which ALS emulation may be performed in accordance with one or more embodiments of the present disclosure. Not all of the depicted components may be required, however, and one or more embodiments may include additional components not shown in FIG. 2B. Variations in the arrangement and type of the components may be made without departing from the spirit or scope of the claims as set forth herein. Additional, fewer, and/or different components may be provided.

The environment 280 includes an image capture device 282 (e.g., a camera) and a processing system 284. The image capture device 282 may include detectors/sensors to capture an image of a scene within a field of view of the image capture device 282. The image capture device 282 may capture individual static images and/or a series/sequence of images (e.g., according to a frame rate) in a video sequence. In some implementations, the images may include streamed images that are captured by the image capture device 282. In various embodiments, the environment 280 may be implemented in a user device, such as a smartphone, a tablet, or a laptop, or other system or device and the image capture device 282 may be a built-in camera of the device.

In some embodiments, the environment 280 may be, may include, or may be a part of, the system 100 of FIG. 1, the environment 200 of FIG. 2A. In the illustrated embodiment, the processing system 284 includes a programmable logic device 286 and a host processor 290 (e.g., an instruction processor). The PLD 286 may include image processing logic (e.g., image processing logic 235 of FIG. 2) and one or more interfaces 283 configured to provide communications to and/or from image capture device 282. In various embodiments, the interfaces 283 may include an image capture interface, a control interface, and/or other interfaces. The interfaces may include, for example, a GPIO interface, an I2C interface, USB interface, a MIPI CSI interface for image capture, and/or other interfaces.

In some embodiments, the PLD 286 may be a RISCV device and implemented as a computer vision FPGA including an image processing pipeline that is designed to interface with a host processor 290. In some embodiments, the processing system 284 may be implemented as a single processing unit, as multiple processing units, and/or in other configurations. The PLD 286 may receive the images from the image capture device 282 via the interfaces 283 and/or from other sources (not shown), such as from a memory that stores images for retrieval and processing by the PLD 286. As an example, in some cases, the interfaces 283 may support MIPI CSI.

The PLD 286 may further comprise a circuitry and/or logic, such as Lux 288, for generating luminance values from the captured images. In various embodiments, PLD 286 and Lux 288 may be configured to receive image frame(s) and generate ALS and/or ACS data. Lux 288 may be configured to generate Luma and chroma statistics associated with the pixels of a received image and/or a subset of the pixels (e.g., which may be represented as a grid of pixels). In some embodiments, the statistical collection may be performed in the hardware which may include an ALS hardware block, and the computations may be performed in the PLD 286, host processor 290, or other a logic device which may be further configured using firmware. In some embodiments, the Lux 288 may be implemented as ALS block 240 of FIG. 2A.

In various embodiments, the systems and method may further include image grid selection, elimination of outliers, an imaging sensor agnostic programmable lookup table (LUT) stored in a memory such as memory 294, dynamic and/or autonomous rate of ALS reporting, fusing of ALS reporting with other sensor data, and other techniques. In some embodiments, the environment 200 includes a companion chip, such an artificial intelligence FPGA chip. In various embodiments, fused data may include audio data (e.g., identifying user activity), sensing of input activity (e.g., use of keyboard or pointing device), video sensing (e.g., sensing the presence of the user). For example, sensed user presence data may be reported along with the ALS data to the host system and may be used for ALS-related determinations and control (e.g., the system may increase brightness of the display on a sunny day if the user is present, but maintain a lower brightness setting or turn off the display when a user is not present).

In an example operation, the processing system 284 is configured to set up ALS-enabled settings, which may include display settings and power settings. In some implementations (e.g., a user device such a mobile phone or laptop computer), a host application and/or framework that manages the display power settings is configured to setup various parameters and features of the environment 280. In some implementations, ALS emulation is enabled, and a polling interval is defined for exchanging ALS data between the PLD 286 and host processor 290 (e.g., reading ALS parameters every 1 sec). In some implementations, color temperature emulation may be enabled, and a corresponding polling interval is defined (e.g., reading color temperature parameters every 5 sec). The polling rate may be managed by the PLD 286. In some implementations, the host processor 290 will perform on-demand, one-time readings in accordance with a system configuration.

The PLD 286 is configured to computes pixel averages for calculating ambient light and/or color temperature. In some implementations, the PLD 286 will wait for a start of an image frame received from the image capture device 282 and perform data collection operations on the pixels of the image frame. For ALS emulation, the pixel average may be computed for the frame, per grid, or other pixel groupings. For color temperature, a pixel average per RGB color may be computed for the selected pixel groupings. At the end of the frame that aligns with polling rate, the pixel averages may be sent to the host processor 290.

In some embodiments, firmware is configured to select a corresponding conversion factor based on gain and exposure settings. The luminance values (Lux) may be computed for the current image frame based on a scene condition. The Kelvin value of the color temperature may be computed for the current image frame based on a scene condition.

An interrupt may be generated to the host processor, which services the interrupt (e.g., via polling logic 292) by reading output registers. The host processor may then evaluate the received values and take appropriate steps to modify power and/or display settings. ALS operations may then be paused until the next polling interval, allowing the PLD 286 and host processor 290 to enter a low power mode until a next polling interval.

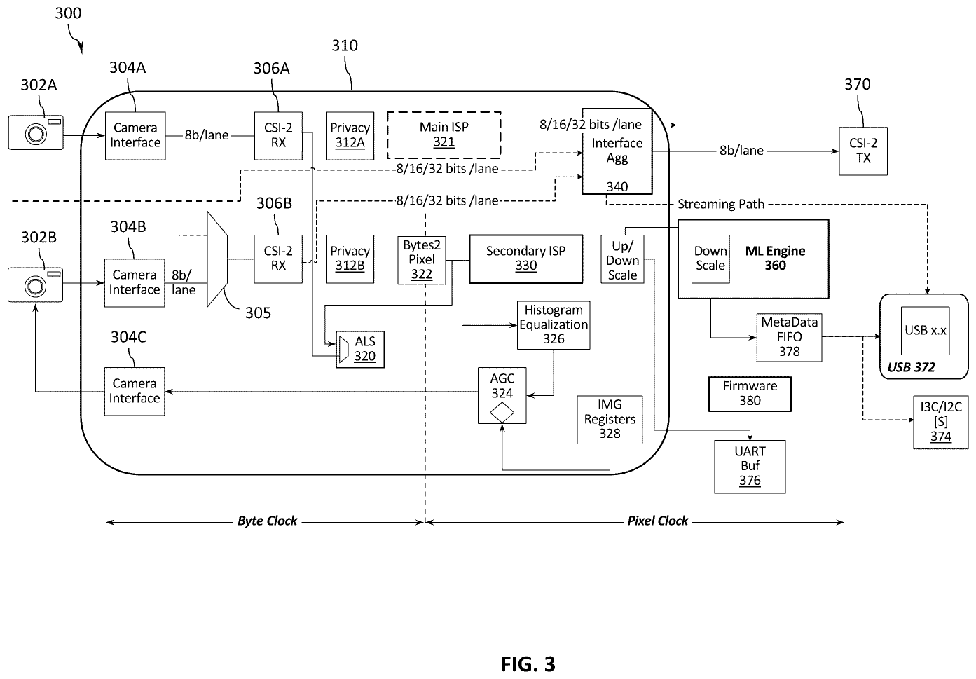

FIG. 3 illustrates an example implementation of logic and/or circuitry (e.g., logic device 100 of FIG. 1, PLD 225 of FIG. 2, and/or other processing arrangement) for an image processing pipeline 300 of a system (e.g., system 100, environment 200) including ALS emulation in accordance with one or more embodiments of the present disclosure. Not all of the depicted components may be required, however, and one or more embodiments may include additional components not shown in FIG. 3. Variations in the arrangement and type of the components may be made without departing from the spirit or scope of the claims as set forth herein. Additional, fewer, and/or different components may be provided.

The image processing pipeline 300 includes one or more imaging devices, such as camera 302A and camera 302B and an imaging pipeline 310 configured to receive and process images from the imaging devices for use by the image processing pipeline 300 (e.g., for object detection via a machine learning engine 360), display on a user device, storage as a photo, manipulation in an application, or other use. In the illustrated embodiment, the camera 302A and camera 302B capture image data and transfer the image data to the imaging pipeline 310 through a camera interface, 304A and 304B, respectively.

In some embodiments, the camera interfaces 304A and 304B may be a Mobile Industry Processor Interface (MIPI) D-PHY interface, or other interface(s) facilitating reliable data transfer and/or control signals between the camera 302A and camera 302B and the imaging pipeline 310. In some embodiments, camera interface 304C may be an inter-integrated circuit interface (I2C) which is a communication protocol allowing data and control signals to be exchanged between a camera sensor and the image processing pipeline 300.

The image processing pipeline 300 may further include a static boot time multiplexer 305 (multiplexer), which configures the startup configuration of the imaging pipeline 310 during its power-up sequence, allowing the system to be configured for a default mode of operation from the start. In some embodiments, the image pipeline further includes a Camera Serial Interface 2 (CSI-2) receiver (e.g., CSI-2 306A and CSI-2 306B) for receiving image data from a corresponding camera 302A and camera 302B, respectively. CSI-2 facilitates the transfer of image and video data facilitating high-quality image processing.

Privacy blocks 312A and 312B may be incorporated into the FPGA-based ISP, allowing the image processing pipeline 300 to implement privacy measures to provide data privacy and security in image and video processing applications (e.g., video surveillance, video surveillance, military applications, or other applications where captured images contain sensitive information). For example, the privacy blocks 312A-B may be configured to protect sensitive information or image areas (e.g., a person's face, confidential data, etc.), to ensure that sensitive information remains obscured or hidden from the output image. Privacy measures may include, for example, region masking (e.g., specific areas of an image to mask or hide, such as faces, license plates, personal identification, or other sensitive content), pixel value modification (e.g., blur, pixelate, replace content with solid color), configurable privacy settings, and/or other privacy measures.

The image pipeline 310 further includes a main image signal processor (Main ISP 321), configured to process the image data captured by the camera 302A and/or camera 302B into final image that can be displayed, stored, analyzed, processed, and/or transmitted. The main ISP 321 may further include a bytes to pixel converter 322, to convert the raw image data to color pixel values. A secondary ISP 330 performs additional image processing, such as gamma correction to compensate for the nonlinear response of the display or image sensor, to generate an image with improved brightness and contrast, and dynamic gain control.

In various embodiments, the main ISP 321 and/or secondary ISP 330 may be configured to perform image processing including demosaicing, white balance adjustment, color correction, noise reduction, sharpness enhancement, exposure control, image compression, post-processing features (e.g., face detection, object recognition, image stabilization, etc.), and/or other image processing.

The imaging pipeline 310 further includes one or more image registers (e.g., IMG registers 328) and/or other memory elements. In various embodiments, the IMG registers 328 hold pixel data or other image information during image processing operations. The imaging pipeline 310 further includes a histogram equalization block 326, which may be used to enhance the contrast of an image and thus improve the overall quality of the image. The histogram of the image may represent the distribution of pixel intensities, where the x-axis represents the intensity levels (e.g., ranging from 0 to 255 in an 8-bit color image), and the y-axis shows the frequency or number of pixels at each intensity level.

Interface Aggregation 340 functions to facilitate communication between different system components by aggregating captured image data and providing a common interface. Various output blocks may include a CSI-2 transmission block 370, one or more USB devices 372, 13C Sensewire and/or I2C protocol block 374, a Universal Asynchronous Receiver/Transmitter (UART) buffer 376 which is used to temporarily store image data to be transmitted, metadata first-in-first-out (FIFO) buffer 387, and other blocks. In some embodiments, the system may further include a machine learning engine 360, which may be used for image analysis such as object detection and classification tasks.

The ambient light sensor emulator 320 receives pixel data for the image and calculates ambient light and/or color temperature data as described herein. In various embodiments, a Lux value of ambient light is derived from the image pixel values. The Lux value may be calculated from an RGB image, a grayscale image, and/or other image configurations. In some implementations, the ambient light sensor emulation processing and RGB color temperature processing are implemented in the ALS 320 hardware and the firmware 380 (e.g., firmware from a RISCV core). The firmware 380 may be configured to tune the ALS 320 emulation on the fly. For example, performance of a deployed system may be improved by calibration on the brighter range and/or darker range. In the illustrated implementation, the data collection and computation are primarily performed in hardware, while the tuning, characterizing, and generating the output are performed primarily in the firmware.

In some implementations, the ALS 320 is a hardware block configured to receive frames of a captured image comprising a plurality of pixel values and output an ambient light value (e.g., Lux) and a color temperature value (e.g., Kelvin). The ALS 320 may be implemented as a block of a programmable FGPA with programmable logic configured to function as a pixel to Lux converter and a pixel color to Kelvin converter. The programmable FGPA chip may be customized for a generic imaging sensor and/or for one or more specific image sensors. In some embodiments, the ALS 320 hardware is designed to emulate a generic sensor, and sensor specific adjustments and customizations (e.g., characteristics of the sensors, non-linearity of the responsiveness, etc.) may be provided in the firmware 380.

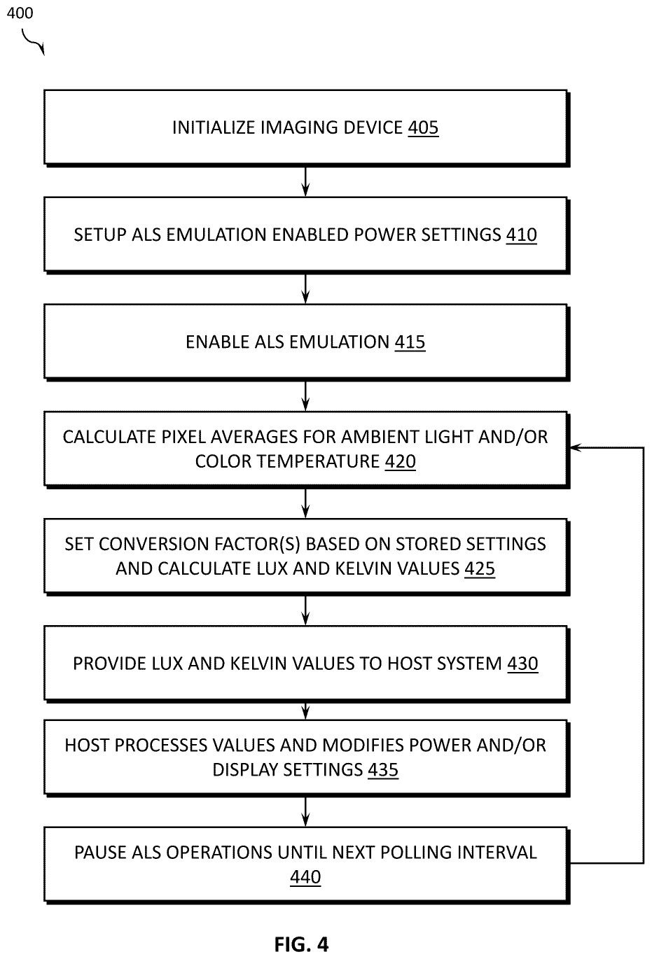

FIG. 4 illustrates a flow diagram of an example process 400 for facilitating ambient light sensor emulation in accordance with one or more embodiments of the present disclosure. In some embodiments, the operations of FIG. 4 may be implemented with any combination of electronic hardware (e.g., inductors, capacitors, amplifiers, actuators, or other analog and/or digital components) and software instructions executed by one or more logic devices associated with corresponding electronic devices, modules, processes, and/or structures depicted in FIGS. 1-3.

It should be appreciated that any step, sub-step, sub-process, or block of the process 400 may be performed in an order or arrangement different from the embodiments illustrated by FIG. 4. For example, in other embodiments, one or more blocks may be omitted from the process 400, and other blocks may be included. Furthermore, block inputs, block outputs, various sensor signals, sensor information, calibration parameters, and/or other operational parameters may be stored to one or more memories prior to moving to a following portion of the process 400. Although the process 400 is described with reference to systems, devices, processes, and elements of FIGS. 1-3, the process 400 may be performed by other systems, devices, and elements, and including a different selection of electronic systems, devices, elements, assemblies, and/or arrangements. At the initiation of the process 400, various system parameters may be populated by prior execution of a process similar to the process 400, for example, or may be initialized to zero and/or one or more values corresponding to typical, stored, and/or learned values derived from past operation of the process 400.

For explanatory purposes, the process 400 is primarily described herein with reference to components of the environments of FIGS. 2-3, although the example process 400 may be utilized with components in other environments. Furthermore, for explanatory purposes, the process 400 is described herein with reference to detecting ambient light and/or color temperature, generating associated assessments, and adjusting display parameters and/or power levels, but may be adapted appropriately as further described herein.

At block 405, the imaging sensor (e.g., image capture device 205, camera 302A, or other imaging sensor(s) of a system) is initialized. The imaging sensor may be initialized and managed by a system on a chip (SoC) imaging sensor driver, by computer vision (CV) FPGA embedded drivers (e.g., when no imaging application such as a video conference application is running), or other system component, driver, or process, as appropriate to the system. In some implementations, the imaging sensor is a 4K camera sensor which is initialized to capture images at 30 frames per see (FPS).

In some implementations, the sensors of the imaging device are tuned and/or configured (e.g., on a sensor-by-sensor basis) in accordance with stored configuration parameters. The stored configuration parameters may be stored in a system memory (e.g., as a lookup table (LUT) in a serial peripheral flash memory). In some implementations, the LUT can be stored in a main memory of the host (e.g., SSD), and can be read by an FPGA or other logic device at any time. The update/configuration process may be system dependent (e.g., through an operating system, firmware, or application update process).

At block 410, the system sets up ALS enabled power settings, which may include display power settings. In some implementations (e.g., a laptop computer), a host application and/or framework that manages the display power settings, will setup various parameters and features.

In some implementations, ALS emulation is enabled, and a polling interval is defined (e.g., reading ALS parameters every 1 sec). In some implementations, color temperature emulation may be enabled, and a corresponding polling interval is defined (e.g., reading color temperature parameters every 5 sec). The polling rate may be managed by a CV FGPA. In some implementations, the host system will perform on-demand, one-time readings in accordance with a system configuration.

At block 415, ALS emulation is enabled. In some implementations, the CV FGPA is configured to enable the ALS block (e.g., ALS 320) when other artificial intelligence functions of the CV FGPA are enabled. If AI functionality is not enabled, the CV FPGA may route the image frames to the AI path. The image frames may be downscaled for optimal processing. The CV FPGA may maintain a shadow copy of the gain and exposure settings from the host SoC.

At block 420, ALS block computes pixel averages for ambient light and/or color temperature. In some implementations, the CV FPGA will wait for a start of an image frame (SOF) and perform data collection operations on the pixels of the image frame. For ALS emulation, the pixel average may be computed for the frame, per grid, or other pixel groupings. For color temperature, a pixel average per RGB color may be computed for the selected pixel groupings. At the end of the frame that aligns with polling rate, the pixel averages may be sent to the RISCV. In some implementations, an interrupt is generated by the CV FPGA hardware to the RISCV firmware. If ALS is the only function enabled, then the FPS may match the polling rate (e.g., 1 FPS).

At block 425, the CV FPGA firmware selects a corresponding conversion factor based on the gain and exposure settings. The luminance (Lux) may be computed for the current image frame based on a scene condition. The Kelvin value of the color temperature may be computed for the current image frame based on a scene condition.

At block 430, when the output readings they are provided to the host system. For example, an interrupt may be generated to a host SoC, which services the interrupt by reading output registers.

At block 435, the host system processes the values and takes appropriate steps to modify power and/or display settings.

At block 440, ALS operations are paused until next polling interval. The SoC will go to idle for ALS operations until the next interval interrupt, and the CV FPGA will go to low power mode until next polling interval (e.g., 1 sec later). At the next polling interval, the sequence of operations 420-440 will repeat as long as ALS emulation is enabled.

The systems and methods described herein with respect to FIGS. 1-4 disclose ambient light sensor emulation in an image processing pipeline to generate a Lux value that may be used for power management, display adjustment, and/or other control functions. The systems and methods may further include ambient color temperature emulation in the image processing pipeline to generate a Kelvin value that may be used for display adjustment and/or other control functions. Among potential advantages of these systems and methods is a reduction in overall system costs by eliminating the need for a dedicated ambient light sensor and mitigating the development costs.

Ambient light sensor emulation may be used by a system having a display to assist in setting screen brightness for power savings and to enhance user experience. For example, in a sunny, outdoor environment, a display screen may be too dim and difficult for a user to read. The system can use ambient light sensor emulation data to adjust the brightness for the outdoor environment. Similarly, in a dark environment, the brightness of the display screen can be dimmed to enhance readability and save power. Ambient color temperature emulation can be used to adjust the tone of the display in accordance with ambient conditions.

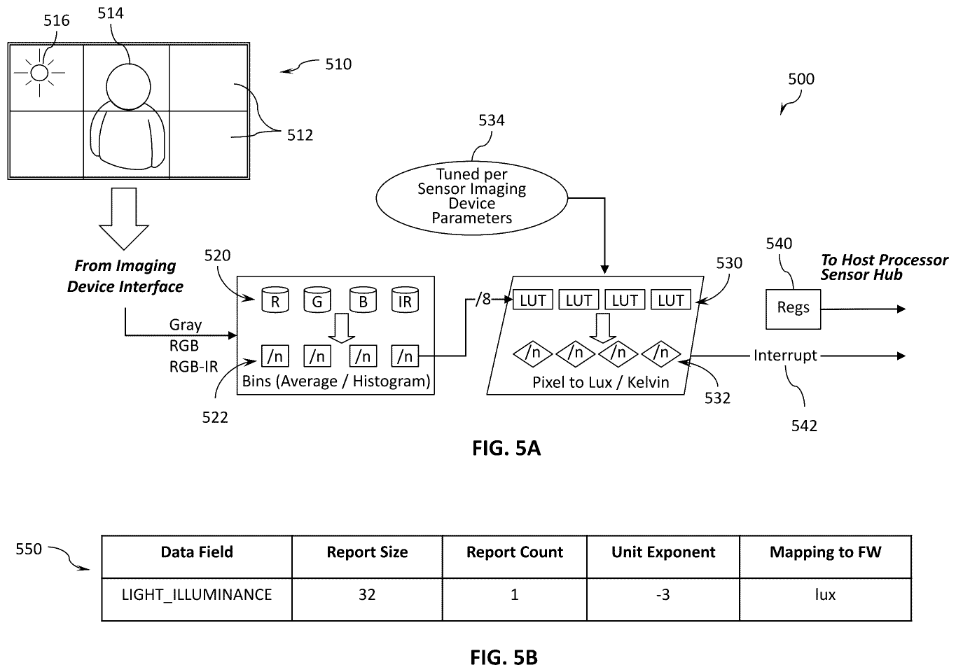

FIG. 5A is a diagram illustrating an example operation of systems and methods in accordance with one or more embodiments of the present disclosure. The example of FIG. 5A may be implemented in and/or using one of more of the embodiments described with respect to FIGS. 1-4.

As illustrated, a system 500 captures and processes an image 510 from an image capture device (e.g., image capture device 205 of FIG. 2A, image capture device 282 of FIG. 2B, camera 302A or camera 302B of FIG. 3, or other image capture device). The image 510 may be processed as a single image or divided into one or more subsets of pixels for processing. For example, the image 510 may be partitioned into an M×N grid, where M is the number of rows and N is the number of columns. In the illustrated embodiment, a 2×3 grid comprises a plurality of grid panels 512 that are separately processed to generate Lux and/or color temperature values representing ambient light. In some embodiments, the ALS hardware is configured to process the full image and/or process a grid or other partition or subdivision of the image, as instructed by the firmware.

In some embodiments, the system may be configured to capture an image of a person 514 in front of the image capture device (e.g., such as a system user during a video conference). The captured image 510 may further include pixels representing bright areas (e.g., a light source 516, such as a lamp or the sun) and pixels representing dark areas (e.g., a black or shadowy area of an image). A bright light in one or more panels of the grid could skew the overall image ALS calculations. Similarly, the presence of a person (e.g., person 514) or object could interfere with the ambient light calculations. To obtain an accurate measure of ambient light, the system may be configured to remove outliers, such as the grid panel 512 with the maximum (Max) Lux value and the grid panel 512 with the minimum (Min) Lux value.

In some embodiments, the image 510 is comprised of one or more of color pixels (e.g., comprising red, green, and blue values), grayscale pixels, color infrared pixels, or other image formats. The pixels for the image 510 or separately for each panel 512 of the image 510 are collected into bins 520. There may be a bin for each color (e.g., red (R), green (G), and blue (B)) or other pixel intensity data (e.g., infrared intensity values). In some embodiments, a single color (e.g., green) or a grayscale pixel values may be used. In some embodiment, each bin 520 collects pixel data for a single pixel value. In some embodiments, each bin collects pixel data for a range of pixel values. The pixel value range for each bin may be calculated as the total number of pixel values for each color (e.g., 2\hat{ }(bits per pixel)) divided by the number of bins (e.g., 32 bins). For example, an 8-bit color image (256 pixels values for each color) may be divided into 32 bins with a pixel range of 8 bits per bin, such that the first bin collects pixel values 0-7, the second bin collects pixel values 8-15, and the 32^{nd} bin collects pixel values 248-255.

The histogram bin values may be collected and averaged across multiple grid panels 512 of the image 510. In some embodiments, the histogram bin values may also be collected and averaged across multiple frames. In some embodiments, statistical outliers are removed from the bin average calculations. For example, the histogram values for each panel 512 may be compared to the histogram values for the other of the panels 512. In one example, the minimum (Min) and maximum (Max) panel values are eliminated from the histogram average calculations for each color to mitigate the effect of bright areas (e.g., a light source) or dark areas (e.g., a person) from the ambient light calculations. In some implementations, the outliers may be determined through other methods which may include calculations of statistical outliers, selection of more than one Min and/or Max panel, or through other methods. In extreme conditions (e.g., outdoors) it is helpful to eliminate light source directly in the image.

Next, the image average pixel values are calibrated/tuned for the image sensor through stored imaging device parameters. In some embodiments, the tuning parameters are stored in firmware, allowing the hardware components to be configured for selected imaging devices. The parameters may address sensor nonlinearity to mitigate inaccuracies or errors in measurements. Pixel to Lux conversion 530 is then applied to generate Lux values. In some embodiments, a lookup table (LUT) is stored in firmware to convert the tuned pixel values to Lux values, which may be averaged across grid panels. The outputs may be stored in one or more registers 540, and an interrupt 542 is triggered to the host processor. The host processor can read and interpret the Lux values to control the display brightness and provide other ALS functionality. In some embodiments, a LUT may be characterized by LUT=log_func (AEK+GK)*Pixel_value+/−BLC, where AEK is an automatic exposure co-efficient, GK is a gain co-efficient, and BLC is offset correction.

FIG. 5B. illustrates an example data structure 550 for transmitting Lux values between the imaging pipeline and the host system. In some embodiments, the data structure follows the host system data structure requirements. Additional reports may be available for the IR component (e.g., indoor vs. outdoor) and pixel to Kelvin conversion. For example, the average RGB values 522 may be converted to Kelvin values via a lookup table mapping RGB colors (e.g., an (R, G, B) color to a Kelvin value).

In view of the forgoing, the output Lux values depend on sensor sensitivity (visible light or IR). The sensor pixel effects may be removed by sensor parameters stored in firmware. The pixel brightness data may be converted to a Lux-equivalent value, where the output is: log_func (AEK+GK)*Pixel+/−BLC. The AE coefficient facilitates removal of the exposure effects, and the gain coefficient facilitates removal of the gain effect. The BLC offset correction is applied. The Lux-equivalent value may be calculated on red, green, and blue color values, or on one or more color values (e.g., calculating Lux on just the green component). In some embodiments, the Lux calculations are performed on greyscale images or optionally applied on IR pixels.

The calibration parameters may be calculated by using the exposure value (EV) from the sensor to compute L=2 \hat{ }(EV−3). For this approach, the information may be available from the sensor manufacturer. The exposure value may be calculated, for example, by computing EV=log₂ N^{2/t}, where N is the f-number, t is the exposure time (e.g., “shutter speed”) in seconds and “3” is used for a sensor between 2.84 to 3.0. In another, approach, the sensor may be calibrated in a lab, for example, with a known Lux source and/or Lux meter. For this approach, a non-linear plot may be generated using experimental results. The data may then be fit to a function used to map the Lux values stored in the lookup table.

Examples of Lux levels

| | | |
|---|---|---|
| Very Bright Summer Day | 100,000 | Lux |
| Full Daylight | 10,000 | Lux |
| Overcast Summer Day | 1,000 | Lux |
| Very Dark Day | 100 | Lux |
| Twilight | 10 | Lux |
| Full Moon | <1 | Lux |

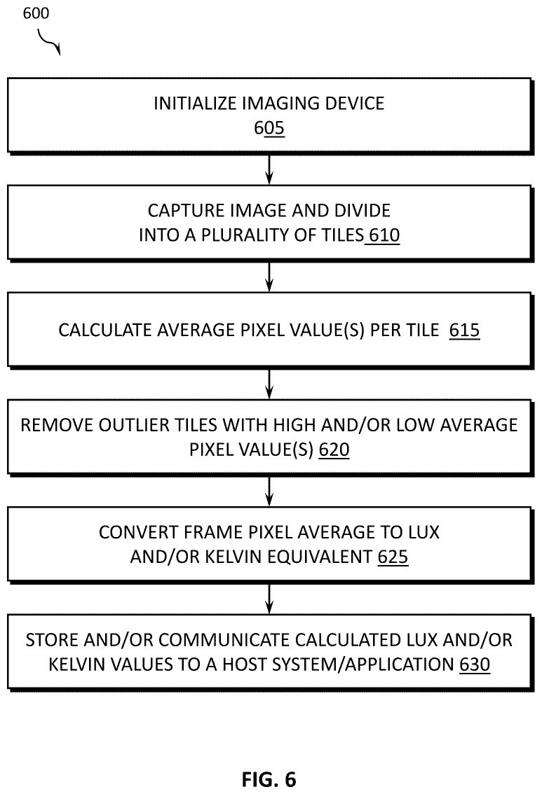

FIG. 6 illustrates a flow diagram of an example process 600 for facilitating ambient light sensor emulation and color temperature determinations in accordance with one or more embodiments of the present disclosure. In some embodiments, the operations of FIG. 6 may be implemented with any combination of electronic hardware (e.g., inductors, capacitors, amplifiers, actuators, or other analog and/or digital components) and software instructions executed by one or more logic devices associated with corresponding electronic devices, modules, processes, and/or structures depicted in FIGS. 1-3 and 5B.

It should be appreciated that any step, sub-step, sub-process, or block of the process 600 may be performed in an order or arrangement different from the embodiments illustrated by FIG. 6. For example, in other embodiments, one or more blocks may be omitted from the process 600, and other blocks may be included. Furthermore, block inputs, block outputs, various sensor signals, sensor information, calibration parameters, and/or other operational parameters may be stored to one or more memories prior to moving to a following portion of the process 600. Although the process 600 is described with reference to systems, devices, processes, and elements of FIGS. 1-3 and 5B, the process 600 may be performed by other systems, devices, and elements, and including a different selection of electronic systems, devices, elements, assemblies, and/or arrangements. At the initiation of the process 600, various system parameters may be populated by prior execution of a process similar to the process 600, for example, or may be initialized to zero and/or one or more values corresponding to typical, stored, and/or learned values derived from past operation of the process 600.

For explanatory purposes, the process 600 is described herein with reference to detecting ambient light and/or color temperature, generating associated assessments, and adjusting display parameters and/or power levels, but may be adapted appropriately for other applications.

At block 605, the imaging sensor (e.g., image capture device 205, camera 302A, or other imaging sensor(s) of a system) is initialized. The imaging sensor may be initialized and managed by a system on a chip (SoC) imaging sensor driver, by computer vision (CV) FPGA embedded drivers (e.g., when no imaging application such as a video conference application is running), or other system component, driver, or process, as appropriate to the system. In some implementations, the imaging sensor is a 4K camera sensor which is initialized to capture images at 30 frames per sec (FPS).

In some implementations, the sensors of the imaging device are tuned and/or configured (e.g., on a sensor-by-sensor basis) in accordance with stored configuration parameters. The stored configuration parameters may be stored in a system memory (e.g., as a lookup table (LUT) in a serial peripheral flash memory). The update/configuration process may be system dependent (e.g., through an operating system, firmware, or application update process).

In some implementations (e.g., the example system illustrated in FIG. 3) the system may include more than one camera or imaging device (e.g., camera 302A and imaging device 302B). Selection of which imaging device to use may depend on location of the imaging devices on the system, the fields of view, and other factors. When an imaging device is not in use by the system, then the ALS system may optimize the configuration for ambient light and color temperature. For example, the imaging device may be initialized to set the gain to 1 and disable automatic exposure control.

In some implementations, the imaging device is tuned/calibrated to ambient light and color temperature calculations. In one approach, the sensor exposure value and other parameters are known (e.g., from the system manufacturer), which facilitates accurate ALS emulation as the Lux equivalent correlates to the sensor response. In a second approach, the ambient value associated with the sensor response may be determined in a lab setting. The ambient light value may be tuned to the sensor using a light meter or other device. In a third approach, a LUT/Log curve may be defined providing scaled conversion. This is third approach may provide a lower cost implementation than the second approach, but may result in a larger error (e.g., 10 lux to 100 lux in some implementations).

At block 610, the imaging device captures one or more images which are processed through an image processing pipeline (e.g., the image processing pipeline of FIG. 3 or other implementation). The captured image may be processed as a full image frame, or be divided into a plurality of tiles. In some embodiments, the grid parameters are stored in firmware allowing the system to be configured using different combinations of rows and columns (e.g., 3×2, 12/8, 8/4, or other combinations. The grid may partition into separate rectangular frames or may include overlapping frames in some implementations. In some implementations, each of the frames may be the same size and shape, different sizes, different shapes, or other groupings of pixels.

At block 615, the system computes average pixel value(s) per tile. In some implementations, a histogram of one or more pixel values is compiled for each tile. In some implementations, the system may be configured to compile data on a single pixel color (e.g., red, green, blue, gray for a grayscale image, infrared image, etc.). In other implementations, histograms may be separately compiled for each image color component (e.g., red, green, and blue for an RGB image). The histograms and average pixel values may be compiled for a single image frame, or across a plurality of image frames.

At block 620, the system removes outlier tiles with low and/or high average pixel values. In some implementations, the tile with the maximum average pixel value is removed, and the tile with the minimum average pixel value is removed. In some implementations, more than one tile may be removed with the n tiles with the highest average pixel value and lowest average pixel values being removed. In other implementations, outlier tiles may be identified and removed through other statistical methods, as appropriate. The grid configuration, outlier identification (e.g., using minimum and maximum) may be configurable through firmware as discussed herein. In one some embodiments, the system is configured to identify and remove tile(s) that include light sources (e.g., a light bulb appearing in the tile) which may skew an ambient light calculation.

At block 625, the average pixel values are converted to lux equivalents. The average pixel values may be converted on a tile-by-tile basis and the lux value for frame computed from those values, and/or the average pixel value may be computed for the whole image frame (without the outliers) and converted to a single lux value. The lux value may be computed for the current image frame based on a scene condition and be used for ambient light sensing applications, such as display and/or power control. A Kelvin value of the color temperature may also be computed for the current image frame by using the average pixel values for each color. Finally, at block 630 the calculated Lux and/or Kelvin values are stored and/or communicated to a host system/application (e.g., storing values in register(s), via an interrupt, etc.).

In some embodiments, a logarithmic scale is used to convert the pixel average values to a Lux equivalent and/or Kelvin equivalent. In some embodiments, one or more lookup tables are generated to map pixel average values to lux values and/or Kelvin values. In some embodiments, the mapping may identify or generalize categories of luminance to identify scenarios where the ambient light driven adjustment may be appropriate. For example, the table below shows an example mapping of pixel values to lux equivalents:

| | Lux | Pixel value |
|---|---|---|
| Full Moon | 1 | 0 |
| Twilight | 10 | 51.2 |
| Very Dark Day | 100 | 102.4 |
| Home | 150 | 111.416 |
| Office | 250 | 122.775 |
| Classroom | 300 | 126.829 |
| Study Library | 500 | 138.187 |
| Supermarket | 750 | 147.203 |
| Overcast day | 1000 | 153.6 |
| Hardware Lab | 1750 | 166.044 |
| Full daylight | 10000 | 204.8 |
| Bright sunny day | 100000 | 256 |

As illustrated in the above example, it may be sufficient for many implementations to provide a mapping of pixel values or ranges to lux values or ranges that are relevant to device brightness control or other power management features.

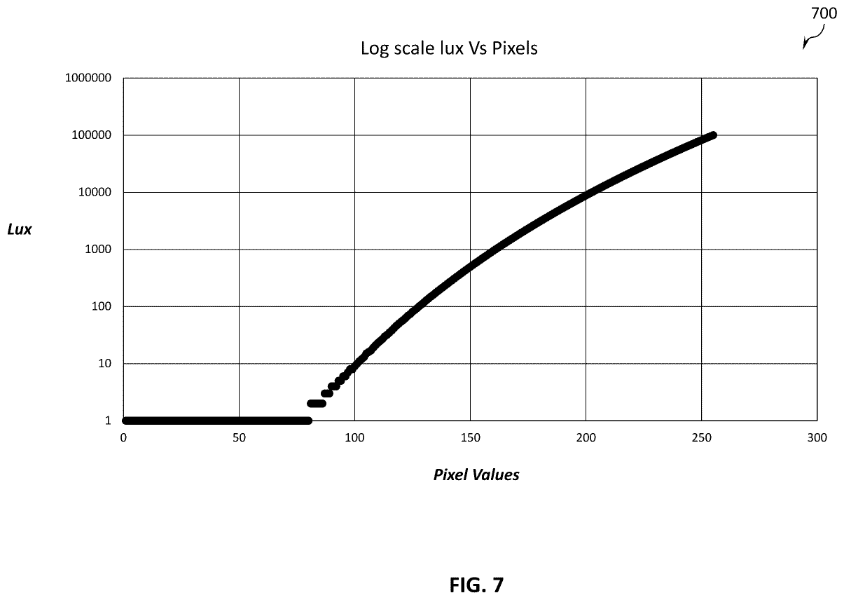

In some embodiments, a mapping table may be stored in firmware to configure the hardware for a particular imaging device and implementation scenario. Multiple tables may be provided to map pixel values for different imaging devices and configurations. In some embodiments, the mapping may include identifying the appropriate lux category for brightness control, for example. In some embodiments, different pixel ranges may be associated with corresponding pixel to lux calculations. For example, FIG. 7 illustrates an example mapping 700 of pixel values to Lux values. In this example, the pixel values in a range from 0 to approximately 75 have a lux value of 1. Different ranges of pixel values are illustrated with associated lux values. For pixel values over 100, the lux values may be calculated using a function that is fit to the data, or by mapping discrete pixel values to their corresponding lux values in a lookup table, as shown above.

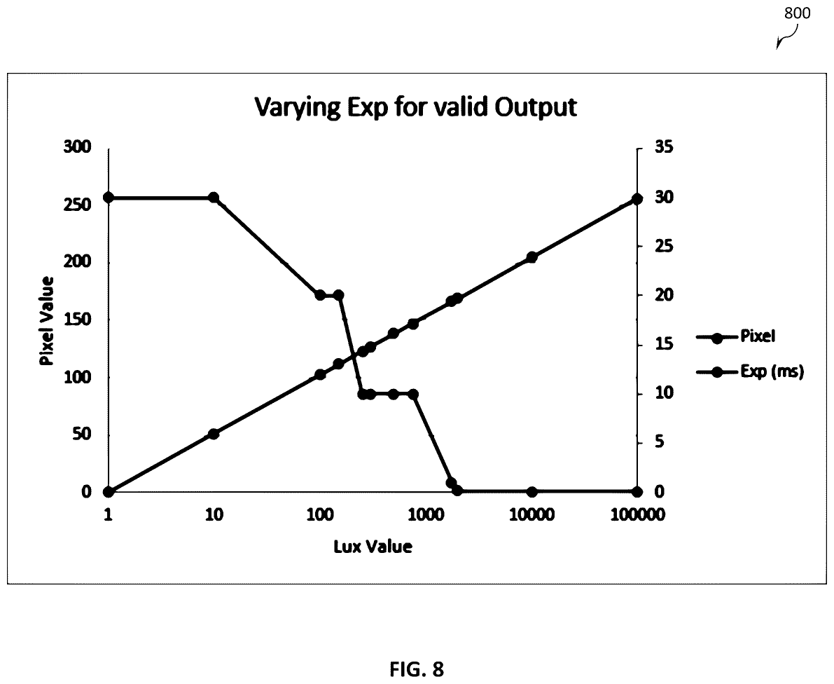

Referring now to FIG. 8, an example graph 800 illustrates a relationship between pixel values and lux values. In various implementations, the system is configurable to add multiple conversion factors for different gain and exposure value sets by the host system, which allows the system to apply different factors for different camera settings.

In view of the foregoing, a system in accordance with FIGS. 1-8 may include a programmable logic device comprising an image processing pipeline comprising hardware components configured to process an image frame received from an image capture device, ambient light sensing hardware coupled to the image processing pipeline and configured to generate an ambient light value from the image frame, the ambient light value representing a measure of ambient light sensed by the image capture device, and a memory configured to store the ambient light value for use by a host system processor. The host system processor may be configured to selectively adjust a power and/or display setting based on the ambient light value. The programmable logic device may be configured to operate in accordance with a polling interval including storing ambient light values in the memory during the polling interval and generating an interrupt to the host processor to read the values from the memory while pausing the ambient light hardware until a next polling interval. User presence data comprising audio, video, and/or user input data may be collected and fused with the ambient light value for use by the host processor.

The ambient light sensing hardware (such as ALS 320 as described in FIG. 3) may be configured to define a plurality of image frame segments (such as panel or tile as further described herein), each image frame segment comprising a plurality of pixels. Each image frame segment may be a panel as a segment of a grid comprising a plurality of panels arranged in rows and columns that partition the image frame. The ambient light sensing hardware may be further configured to collect pixel value data for each image frame segment, and calculate an ambient light value for each image frame segment. Each pixel of the image frame may comprise a red pixel value, a green pixel value, and a blue pixel value, and wherein the pixel value data comprises separate bins of pixel values for each pixel color. The ambient light sensing hardware may be configured to calculate a color temperature value from the red pixel values, the green pixel values, and the blue pixel values. The ambient light sensing hardware may be configured to identify image frame segments with pixel values and/or ambient light values comprising statistical outliers and calculate an ambient light value for the image frame by combining the ambient light values of the remaining image frame segments.

Collected pixel values may be calibrated to the image capture device through stored imaging device parameters to correct for sensor response nonlinearities. Pixels representing one or more light sources in the image frame may be removed prior to generating the ambient light value, for example, by removing outlier image segments. The ambient light value may be calculated using a pixel value to luminance value conversion comprising a mapping stored in firmware to convert tuned pixel values to luminance values. The luminance value may be separately calculated on one or more of red pixel values, green pixel values, blue pixel values, infrared pixel values, and/or grayscale pixel values.

A method in accordance with FIGS. 1-8 may include capturing an image using an image capture device, processing the image through an image processing pipeline, generating an ambient light value from pixels values of the image, the ambient light value representing ambient light sensed by the image capture device, and providing the ambient light value to a host system processor for use in controlling a display brightness and/or power management. The method may further comprise defining a polling interval and the steps of generating the ambient light value and providing the ambient light value to a host system processor are performed once during each polling interval.

The step of generating the ambient light value may further comprise defining a plurality of image frame segments, each image frame segment comprising a plurality of pixels, collecting pixel value data for each pixel color of each image frame segment, and calculating an ambient light value for each image frame segments based on the collected pixel value data. The method may further comprise defining a grid comprising a plurality of panels arranged in rows and columns that partition the image frame, where each image frame segment is a panel of the grid. The step of generating the ambient light value may further comprise identifying frames with pixel values and/or ambient light values comprising statistical outliers and calculating an ambient light value for the image frame by combining the ambient light values of the remaining image frame segments. The step of generating the ambient light value may further comprise collecting pixel value data in a plurality of bins, each bin defining a pixel color and a pixel value range for the pixel color and calculating a color temperature value from the pixel value data.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

1. A system comprising:
a programmable logic device comprising:
an image processing pipeline comprising hardware components configured to process an image frame received from an image capture device;
ambient light sensing hardware coupled to the image processing pipeline and configured to generate an ambient light value from the image frame, the ambient light value representing a measure of ambient light sensed by the image capture device; and
a memory configured to store the ambient light value for use by a host system processor.

2. The system of claim 1 further comprising the host system processor, and wherein the host system processor configured to selectively adjust a power and/or display setting based on the ambient light value.

3. The system of claim 1, wherein the ambient light sensing hardware is configured to define a plurality of image frame segments, each image frame segment comprising a plurality of pixels.

4. The system of claim 3, wherein each image frame segment is a panel of a grid comprising a plurality of panels arranged in rows and columns that partition the image frame.

5. The system of claim 4, wherein the ambient light sensing hardware is further configured to collect pixel value data for each image frame segment, and calculate an ambient light value for each image frame segment.

6. The system of claim 5, wherein each pixel of the image frame comprises a red pixel value, a green pixel value, and a blue pixel value, and/or each pixel of the image frame comprises a gray pixel of a grayscale image; and wherein the pixel value data comprises separate bins of pixel values for each pixel color.

7. The system of claim 6, wherein the ambient light sensing hardware is further configured to calculate a color temperature value from the red pixel values, the green pixel values, and the blue pixel values.

8. The system of claim 7, wherein the ambient light sensing hardware is configured to identify image frame segments with pixel values and/or ambient light values comprising statistical outliers and calculate an ambient light value for the image frame by combining the ambient light values of the remaining image frame segments.

9. The system of claim 6, wherein collected pixel values are calibrated to the image capture device through stored imaging device parameters to correct for sensor response nonlinearities.

10. The system of claim 1, wherein the programmable logic device is configured to operate in accordance with a polling interval including storing ambient light values in the memory during the polling interval and generating an interrupt to the host processor to read the values from the memory; and wherein ambient light sensing hardware is paused until a next polling interval.

11. The system of claim 1, wherein user presence data comprising audio, video, touch sensing data, and/or user input data is collected and fused with the ambient light value.

12. The system of claim 1, wherein pixels representing one or more light sources in the image frame are removed prior to generating the ambient light value.

13. The system of claim 1 wherein the ambient light value is calculated using a pixel value to luminance value conversion comprising a mapping stored in firmware to convert tuned pixel values to luminance values.

14. The system of claim 13, wherein the luminance value may be separately calculated on one or more of red pixel values, green pixel values, blue pixel values, infrared pixel values, and/or grayscale pixel values.

15. A method comprising:
capturing an image using an image capture device;
processing the image through an image processing pipeline;
generating an ambient light value from pixels values of the image, the ambient light value representing ambient light sensed by the image capture device; and
providing the ambient light value to a host system processor for use in controlling a display brightness and/or power management.

16. The method of claim 15 wherein generating the ambient light value further comprises defining a plurality of image frame segments, each image frame segment comprising a plurality of pixels;
collecting pixel value data for each pixel color of each image frame segment; and
calculating an ambient light value for each image frame segments based on the collected pixel value data.

17. The method of claim 16, further comprising defining a grid comprising a plurality of panels arranged in rows and columns that partition the image frame; and wherein each image frame segment is a panel of the grid.

18. The method of claim 16, wherein generating the ambient light value further comprises identifying frames with pixel values and/or ambient light values comprising statistical outliers and calculating an ambient light value for the image frame by combining the ambient light values of the remaining image frame segments.

19. The method of claim 16, wherein generating the ambient light value further comprises collecting pixel value data in a plurality of bins, each bin defining a pixel color and a pixel value range for the pixel color; and wherein the method further comprises calculating a color temperature value from the pixel value data.

20. The method of claim 16, further comprising defining a polling interval, and wherein generating an ambient light value and providing the ambient light value to a host system processor are performed once during each polling interval.
